(19) United States
(12) Patent Application Publication
(10) Pub. No.: US 2015/0170163 A1
(43) Pub. Date: Jun. 18, 2015

(54) SYSTEM AND METHOD FOR CALCULATING AND VISUALIZING RELEVANCE OF SALES OPPORTUNITIES

(71) Applicants: Guido Wagner, Rauenberg (DE); Sven Schrothe, Rauenberg (DE)

(72) Inventors: Guido Wagner, Rauenberg (DE); Sven Schrothe, Rauenberg (DE)

(73) Assignee: SAP AG, Walldorf (DE)

(21) Appl. No.: 14/109,441

(22) Filed: Dec. 17, 2013

(51) Int. Cl. G06Q 30/02

(52) U.S. Cl. CPC G06Q 30/0201

(57) ABSTRACT

A system calculates a relevance of sales opportunities and generates a visualization of the relevance of the sales opportunities. Objects from a customer relationship management (CRM) database and other business application database are accessed to compute an importance score and an urgency score for each object. The importance score is computed based on parameters indicative of an importance of an opportunity. The urgency score is computed based on parameters indicative of an urgency of an opportunity. A relevance score is computed for the objects using the importance score and the urgency score. The objects are ranked based on the corresponding relevance score. A visualization of the objects from the CRM database with relevance scores exceeding a relevance score threshold is generated.

### FIELD

The present disclosure relates generally to processing business data, and in a specific example embodiment, to a system for calculating and visualizing relevance of sales opportunities.

### BACKGROUND

Customer Relationship Management (CRM) software allows business users to enter and keep track of information related to their customers. However, CRM data is often accessed by mobile users using small mobile devices. Due to the relatively small display size of the mobile devices, it is important that the most relevant information be provided to business users. For example, data quality from the CRM data is often not sufficient to provide information on opportunities that require the business user's attention and action.

### BRIEF DESCRIPTION OF DRAWINGS

The appended drawings merely illustrate example embodiments of the present invention and cannot be considered as limiting its scope.

FIG. 1 is a block diagram illustrating an example of a system in which embodiments may be practiced.

FIG. 2 is a block diagram illustrating an example of an Eisenhower matrix.

FIG. 3 is a block diagram illustrating an example a relevance score computation based on the Eisenhower matrix of FIG. 1.

FIG. 4 is a flow diagram of a sales opportunity metamodel, in accordance with an example embodiment, for operation the system of FIG. 1.

FIG. 5 is a block diagram of contributing parameters to determine the urgency to act on an opportunity.

FIG. 6 is a flowchart of a method, in accordance with an example embodiment, for generating a visualization of relevance based on urgency and importance.

FIG. 7 is a diagram illustrating an example of a visualization of an opportunity heatmap.

FIG. 8 is a diagram illustrating an example of a visualization of a list of contacts ranked by relevance of opportunities.

FIG. 9 is a diagram illustrating an example of a visualization of a map showing the most relevant contacts to visit.

FIG. 10 is a block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments. It will be evident, however, to those skilled in the art, that embodiments of the inventive subject matter may be practiced without these specific details. In general, well-known instruction instances, protocols, structures, and techniques have not been shown in detail.

Examples of a system and method for calculating relevance of sales opportunities and generating a visualization of the relevance of the sales opportunities are described. In one example embodiment, objects from a CRM database are accessed to compute an importance score and an urgency score for each object. The importance score is computed based on parameters indicative of an importance of an opportunity. The urgency score is computed based on parameters indicative of an urgency of a sales opportunity. A relevance score is computed for the objects using the importance score and the urgency score. The objects are ranked based on the corresponding relevance score. A visualization of objects from the CRM database with relevance scores exceeding a relevance score threshold is generated.

The system described herein provides an application that allows sales oriented business users to act upon current relevance of sales opportunities and leads. The application leverages data from a CRM system and data from other business application systems to provide a personalized and context sensitive insight into relevant opportunities and leads. For example, the relevant opportunities may be based on strategic alignment of the sales pipeline, trends, and analysis of historical pipeline information. Additionally, the application may provide reporting of historical values and simulate the effect of certain actions on pipeline and sales strategy.

The application may include a mobile device based application. For example, a business user may want to obtain the most relevant information on their mobile device. Such information may include, for example, a short list of leads (e.g., contact information and related information such as sales order history) ranked by relevance, contact information for customers that may need a follow up, reminders and to-do lists that include relevant sales related activities to complete, or a trip itinerary prioritized based on sales opportunity. For example, the trip itinerary may be optimized by the potential of the sales opportunities instead of travel distance and time.

In one embodiment, the application leverages parameters maintained in the CRM database to compute the most relevant opportunities. Examples of such parameters include:

Opportunity source, size, type, phase, category;

Involved product hierarchies and typical sales cycle;

Contacts at business partners and their roles, activity history, contact rate;

Opportunity phase changes, pipeline velocity;

User or team achievements;

Commission schema including incentives for products;

Customers and customer satisfaction, sales cycle info;

Risks on customers;

User location; and

Definition of strategy related sales standards.

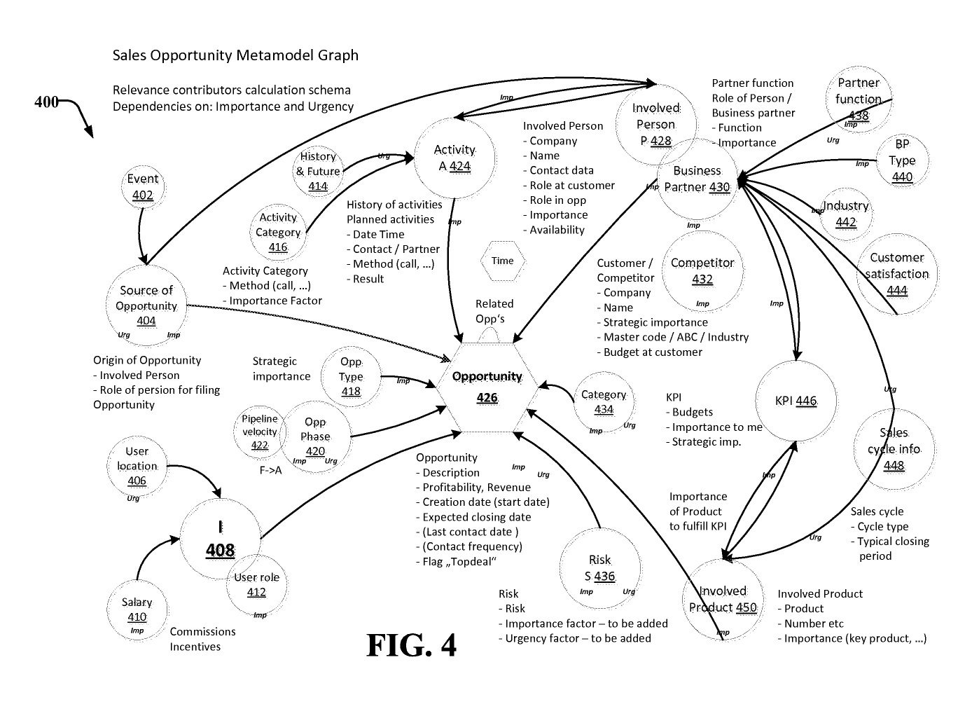

A metamodel may be formed to define how the parameters from the CRM database and other databases relate to one another. In one embodiment, the metamodel may be based on an in-memory database system including a CRM data model enriched by customizing data required for a relevance calculation. For example, the metamodel may utilize CRM data that use the following attributes: opportunities and related attributes, business partners and related attributes, business activities, past and scheduled attributes, and product hierarchies attributes. An example of a metamodel is illustrated and described further below with respect to FIG. 4. The results of a set of calculation views performed on the CRM data and other system data using the metamodel are rendered and can be visualized in a browser or an application of a mobile device.

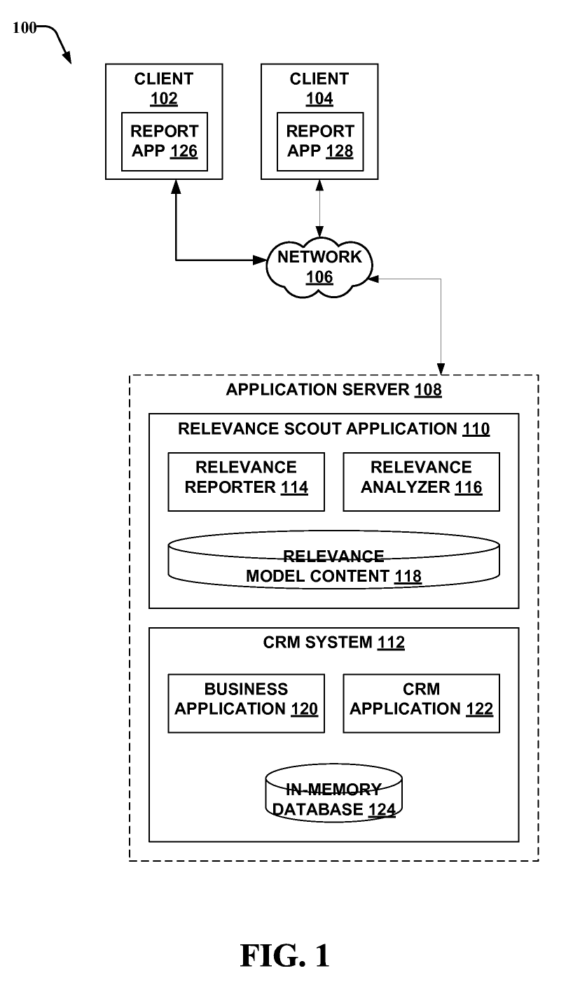

With reference to FIG. 1, a system 100 in which example embodiments may be practiced is shown. The system 100 comprises clients 102 and 104 accessing an application server 108. Clients 102 and 104 are communicatively coupled to the application server 108 via a computer network 106. The computer network 106 may comprise, for example, one or more of a wired or wireless network, a local area network (LAN), or a wide area network (WAN).

Clients 102 and 104 may include a reporting application 126, 128 to provide CRM related data to a CRM system 112. In another embodiment, the reporting application 126 may provide data to a system outside the CRM system 112.

In one embodiment, the application server 108 may include, for example, a relevance scout application 110 and a CRM system 112. The relevance scout application 110 may generate a visualization of the most relevant sales leads (e.g., sales opportunities) in a mobile device of a business user based on calculations from a metamodel of data from CRM system 112. In one embodiment, the relevance scout application 110 includes a relevance reporter 114, a relevance analyzer 116, and a relevance model content 118.

The relevance reporter 114 accesses a plurality of objects from a CRM database to compute an importance score and an urgency score for the plurality of objects. The importance score may relate to important opportunities having an outcome that leads to the achievement of goals set by the business user (e.g., reaching a sale figure). The urgency score may relate to urgent opportunities that demand immediate attention from the business user (e.g., end of quarter deadline).

The importance score is calculated based on a first plurality of parameters indicative of an importance of a sales opportunity. Examples of the first plurality of parameters include an effort spent parameter (e.g., how much time/how many time was spent with the customer), a revenue parameter (e.g., sales number goal), a sales phase parameter (e.g., demand generation or shortly before closing the deal), an opportunity type parameter (e.g., strategic customer), a source parameter (e.g., call from customer), a product parameter (e.g., Database products), a partner parameter (e.g., the customer or an employee of the customer), an industry parameter (e.g., Banking), a risk parameter (e.g., high risk), a customer satisfaction parameter (e.g., not satisfied customer according to last survey), a top deal parameter (e.g., strategic deal), an KPI achievement parameter (e.g., closing deal-sales KPI fulfilled 105%), and an incentive parameter (e.g., deals with this products are payed with double commissions). The importance score may be calculated as the sum of the first plurality of parameters (e.g., adding the corresponding scores of the parameters).

In one embodiment, the importance score is based on Contributors leveraging CRM data:

I_{Effortspent}=Number of activities for Opportunities×Spent-effort importance factor

I_{Revenue}=Expected Revenue from corresponding entry in table in CRM data×Revenue importance factor

I_{Phase}=Importance factor of Phase from corresponding entry in table in CRM data.

I_{Opptype}=Importance factor of Opportunity type from corresponding entry in table in CRM data

I_{Forecastcat}=Importance factor of Forecast from corresponding entry in table in CRM data

I_{Source}=Importance factor of Source from corresponding entry in table in CRM data

I_{Product}=Sum of values from corresponding entries in table for all involved products from CRM data

I_{Partner}=Sum of values from corresponding entries in table for all involved partners from CRM data

I_{Partnerfct}=Sum of values of corresponding entries in table for involved partner functions if partner is a person For example, an opportunity is as more important as more highly relevant employees of a customer are involved, like CEOs (Business Partner can be a company or an employee)

I_{Industry}=Sum of values of corresponding entries in table for involved industries if partner is company. For example, a customer can work in several industries. Each industry is of different importance to the KPIs a salesman needs to fulfill.

In another embodiment, several contributors may require customization of the information source:

I_{Risk}=Importance factor from corresponding entry in table CRM data to Risk information source

I_{CustSatis}=Importance factor from corresponding entry in table in CRM data to Customers satisfaction info source

I_{Topdeal}=Importance factor from Parameter “Topdeal importance” according to flag “Topdeal” in CRM data

I_{Achievements}=Importance factor from corresponding entry in table in CRM data to Target/Achievement info source

I_{Incentive}=Importance factor from corresponding entry in table in CRM data to quantified incentive info source

Based on the previously described parameters, the relevance analyzer 116 calculates the overall importance of opportunity as the sum of the importance contributors:

I_{Opp}=I_{Effortspent}+I_{Revenue}+I_{Phase}+I_{Opptype} I_{Forecastcat}+I_{Source}+I_{Product}+I_{Partner}+I_{Partnerfct}+I_{Industry}+I_{Risk}+I_{CustSatis}+I_{Topdeal}+I_{Achievements}+I_{Incentive}+I_{Userrole}+I_{RevBudget}

Similarly, the relevance reporter 114 calculates the overall importance of opportunities in a pipeline of a user or team as the sum of importance of opportunities of user or team as illustrated in equation (1) below:

$${I}_{User} = \text{?} \text{?} \\ \text{?} \text{indicates text missing or illegible when filed} \qquad ( 1 )$$

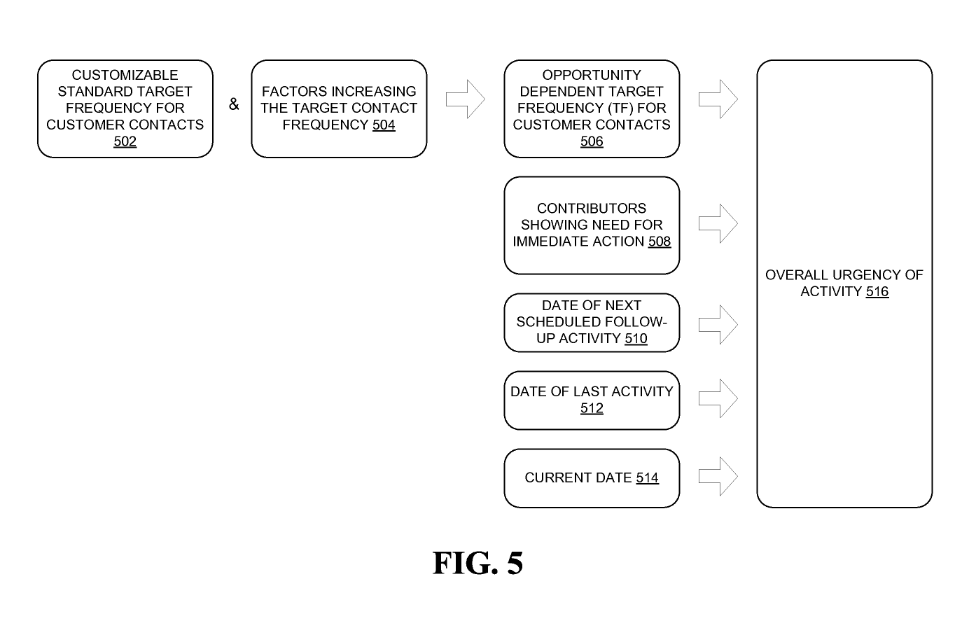

The relevance reporter 114 may compute the urgency score based on a second plurality of parameters indicative of an urgency of a sales opportunity. Examples of the second the second plurality of parameters include an target frequency parameter, calculated from a standard target frequency (e.g., e.g. it is a cultural aspect that there should be a dicrect contact to the customer at least each week and factors changing this standard frequency (e.g. because customer currently is not satisfied), an immediate action parameter (e.g in case of a new product version available, the customer should be informed immediately), a follow up activity parameter (e.g., in case in a former meeting a follow-up with deadline was defined), a data of last activity parameter (e.g., if the last visit at the customer is longer ago than two weeks), a closing date parameter (e.gif the expected closing date is soon, then a contact becomes urgent). The opportunity dependent target frequency parameter may be based on a customizable standard target frequency for customer contacts parameter and an increasing target contact frequency parameter. FIG. 5 illustrates an example of an urgency score calculation schema.

An opportunity dependent target frequency for customer contacts 506 is based on a combination of the customizable Standard Target Frequency STF for customer contacts 502 and factors increasing the target contact frequency 504. The opportunity dependent target frequency for customer contacts 506 Is calculated from a standard target frequency and factors increasing this standard frequency. The customizable standard target frequency STF for customer contacts 502 includes a fix rate, e.g. one visit every two weeks. The factors increasing the target contact frequency 504 include factors based on customer satisfaction (higher rate if customer not satisfied), partner category (more frequent rate if business partner has a leading function, former activities (higher rate if historic rate was too low).

Other contributing parameters include: contributors showing need for immediate action 508, date of next scheduled follow-up activity 510, date of last activity 512, and current date 514.

The following equations illustrate an example of a computation of a TF parameter:

Overall target frequency TF [1/day]=standard target frequency (STF, Parameter)/max of individual frequency factors:

TF=STF*max(UF_{Acthistory}, UF_{Revenue}, UF_{Phase}, UF_{Forecastcat}, UF_{Source}, UF_{Product}, UF_{Partnerfct}, UF_{Closingdate}, UF_{PipVelo}, UF_{Salescycle}, UF_{Risk}, UF_{CustSatis}, UF_{Topdeal})

Example: TF=0.065 per day*1.4=0.09 per day

UF represents an Urgeny Factor that may influence the standard target frequency.

The immediate urgency contributors UI may be defined as follows:

UI_{Location}=Urgency of location (In case of traveling)=Standard Visit Distance (SVD)/Distance from current location to location of contact person

For example, UI Location=30 km/30 km=1. Further immediate urgency contributors may be defined.

The Follow-Up factor FU may be defined using the following equation:

Follow-up-factor FU=days between scheduled follow-up activity and day of last activity TD (time distance)*overall target frequency TF

For Example, FU=15 days*0.09 per day=1.35

The Overall Urgency of Activity 516 may be defined using the following equation:

Urgency of activity U_{A}=(days between today and day of last activity TD (time distance)*overall target frequency TF)+Sum of Immediate urgency contributors−Follow-up-factor FU

For Example, U_{A}=10 days*0.09 per day+1−1.35=0.55

The Urgency parameter may also be defined as the time since startdate multiplied with factors from phase, type, partner, and industry.

Referring back to FIG. 1, the relevance reporter 114 accesses a first set of data from the CRM database and a second set of data from at least one system external to the CRM database. The relevance reporter 114 then augments the first set of data with the second set of data having a same structure as the first set of data and forms the opportunity metamodel using the augmented first set of data. In one embodiment, the relevance reporter 114 is a component that handles the data transfer of relevance data to the user interface. Relevance data is calculated by the relevance analyzer 116, which uses the previously described metamodel. CRM application and Business application like HR system or Marketing system can be sources of information that are used by the relevance analyzer 116. For example, Opportunity ABC is about selling goods XYZ to a customer. The relevance analyzer 116 pulls data from CRM regarding the customer and the opportunity, and from HR regarding the users KPIs and from marketing regarding the current customer satisfaction status. All Importance and urgency factors are calculated by the relevance analyzer 116. The results are visualized and sent to the user interface via the reporting application 126.

The relevance analyzer 116 computes a relevance score for the plurality of objects using the calculated importance score and the calculated urgency score as previously described. The relevance score may be defined as something (A) is relevant to a task (T) if it increases the likelihood of accomplishing the goal (G), which is implied by T.

An example of the relevance score may be calculated using the following equation:

R=\sqrt{I²+U²}

where R represents the relevance score, I represents the calculated importance score, and U represents the calculated urgency score.

The relevance analyzer 116 may further rank the plurality of objects based on their corresponding relevance scores, and generate a visualization of one or more objects from the plurality of objects with corresponding relevance scores exceeding a relevance score threshold. The relevance score threshold may be a user defined or a predefined threshold score. Examples of visualizations are illustrated in FIGS. 7-9 and described further below.

In another embodiment, the relevance analyzer 116 customizes the augmented first set of data in response to a user input and forms the opportunity metamodel using the customized and augmented first set of data. For example, information sources from a CRM application 122 are used and enriched by customizing data stored in “shadow tables,” which have the same structure as the corresponding CRM tables. By doing this, all information required for the relevance calculations is available by customizing, and no data is required to be entered by the user. The opportunity metamodel may be stored in the relevance model content 118. In other words, the metamodel is predefined in the system and describes which factors exist. Calibration parameters are stored in the “shadow-tables.” The relevance analyzer 116 brings all information together by using the described equations.

In another embodiment, the relevance analyzer 116 may also customize parameters. For example, the user may want to obtain deeper insights by changing some aspects of the calculation schema or may want to simulate the impact of changes (for example, in Key Performance Indicators (KPIs)). For this reason, the following customizable parameters may be used in addition to the CRM data and the shadow tables:

Standard deal size (wished median of the deal size)

Standard target contact frequency (how often should a customer facing activity take place)

Standard no-contact-time alarm threshold (time when an alarm should be triggered when there are no activities)

Revenue importance factor (how relevant is expected revenue compared to the other parameters)

Spent-effort importance factor (required to calculate the importance contribution by the effort already spent)

Standard Visit Distance and Relevance-per-distance factor (required to determine which contact is most important to visit in case of traveling)

“Topdeal” importance and urgency parameters (parameters to evaluate the flag “topdeal”)

In another embodiment, the relevance analyzer 116 computes the importance score I by applying the opportunity metamodel stored in relevance model content 118 to the first plurality of parameters. The relevance analyzer 116 then computes the urgency score U by applying the opportunity metamodel to the second plurality of parameters.

The relevance model content 118 may generate and store the metamodel data. For example, the metamodel includes a calculation model (what is stored is the relevance data calculated based on the metamodel). The information metamodel used to calculate importance I and urgency U of sales opportunities may contain data from the CRM system and from systems using data related with opportunities or customers.

The following is a list of parameters used to calculate Importance of opportunity:

Expected revenue

Opportunity Phase

Opportunity Type

Forecast Category

Opportunity Source

Involved Product hierarchies

Involved Business partners & functions, industries

Already spent efforts

Customer satisfaction
Status of personal or team target achievement
Risks on Opportunities
Commissions and incentives for user
Role of user (responsibilities)
Flag “Topdeal”
Customers estimated budget
The following is a list of parameters used to calculate Urgency of activity:
Expected revenue
Opportunity Phase
Opportunity Type
Forecast Category
Opportunity Source
Involved Product hierarchies
Involved Business partners functions
Time to closing date
Frequency of former and planned activities
Time since last change of Opportunity Phase
Pipeline Velocity (Time from F→D)
Typical sales cycle of products, adjusted by typical customer sales cycle
Flag “Topdeal”
Customer satisfaction
Risks on Opportunities
Customers estimated budget
Trends analyzed by Opportunity Scout

The CRM system 112 may be configured to operate a business application 120 and a CRM application 122. Both business application 120 and CRM application 122 may access and store data from an in-memory database 124. The relevance scout application 110 may include a software application configured to compute business processes such as projecting sales, keeping track of inventory, computing sales for items based on location and time, and so forth.

The in-memory database 124 may include a database management system that primarily relies on main memory such as RAM for computer data storage. It is contrasted with database management systems that employ a disk storage mechanism. One example of an in-memory database is the HANA system from SAP AG of Walldorf, Germany. The in-memory database 124 may be configured to store data related to the business application 120 and CRM application 122. Such data may include, for example, sales figures, employment figures, costs, projected revenues, delay percentages, inventory stock management, sales amount, contact information, and so forth.

While the example embodiment of FIG. 1 shows relevance scout application 110 and CRM system 112 in one server system (e.g., application server 108), alternative embodiments may contemplate the various components of the multiple applications 110 and 112 being embodied within several systems (e.g., cloud computing system, server farm system).

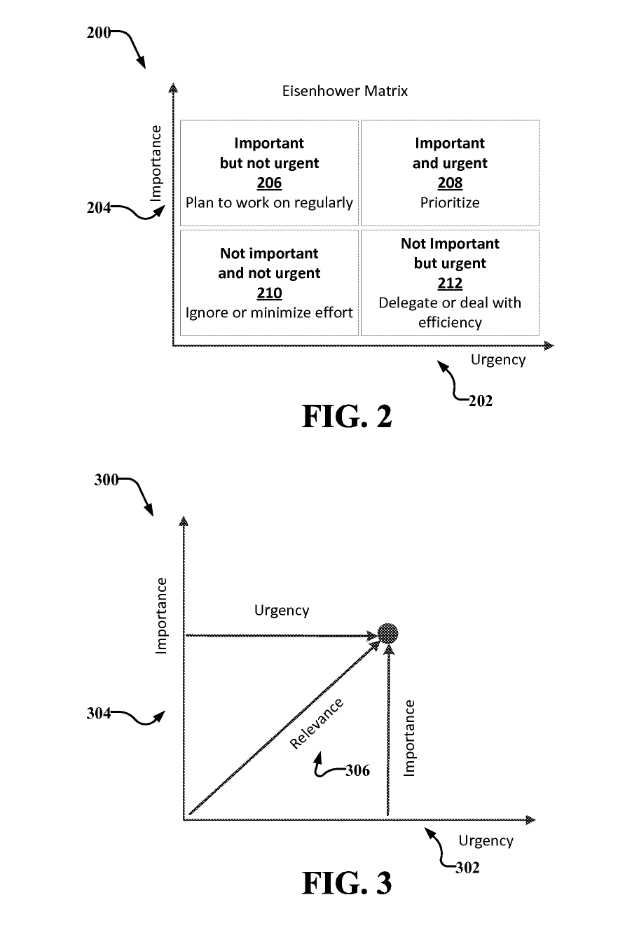

FIG. 2 is a block diagram illustrating an example of an Eisenhower matrix 200 based on time management theory. The horizontal axis 202 represents urgency. The vertical axis 204 represents importance. The matrix 200 is divided into four quadrants: Important but not urgent quadrant 206, Important and urgent quadrant 208, Not important and not urgent quadrant 210, and Not important but urgent quadrant 212.

Business tasks may thus be evaluated using the criteria important/unimportant and urgent/not urgent and put in according quadrants. Tasks in unimportant/not urgent quadrant 210 are dropped, tasks in important/urgent quadrant 208 are taken care of immediately and personally, tasks in unimportant/urgent quadrant 212 are delegated, and tasks in important/not urgent quadrant get an end date and are performed personally 206.

The matrix may be applied towards sales opportunities and leads that intrinsically have a certain importance opportunity and urgency opportunity to the user. As such, important opportunities may be defined as opportunities with outcomes that lead to the achievement of goals. Urgent opportunities may be defined as opportunities that demand immediate attention and most probably action to be taken.

FIG. 3 is a block diagram illustrating an example of graph 300 showing a relevance score computation based on the matrix 200 of FIG. 2. The horizontal axis 302 represents urgency while the vertical axis represents importance.

The “relevance” R 306 of an object is here defined as being calculated from urgency U and importance I as illustrated in the graph 300 using the following equation:

R=\sqrt{I²+U²},

where R represents relevance, U represents urgency, and I represents importance.

FIG. 4 is a diagram illustrating an example of sales opportunity metamodel graph 400, in accordance with an example embodiment, for operation of the system of FIG. 1. The Importance 408 may be based on user location 406, salary 410, and user role 412. The relevance of an opportunity 426 may depend on the importance 408, the pipeline velocity 422, the opportunity phase 420, the opportunity type 418, the source of opportunity 404, the activity 424, involved person 428, the business partner 430, competitor 432, the Category 434, the involved product 450, and the risk 436.

The source of opportunity 404 may be based on event 402. The origin of opportunity 426 may be based on involved person 428 and the role of the person for fulfilling the opportunity.

The activity 424 may be based on a history and future activities 414, and activity category 416. The history and planned activities 414 may include dates and times, contact information, method of activities, and results. The activity category 416 may include method of activity and importance factor.

The involved person 428 may include information related to the company, name and contact data, customer role, opportunity role, importance, and availability.

The business partner 430 may include partner functions, role of the person, and function and importance of their role. For example, the business partner 430 may be based on partner function 438, business partner type 440, industry 442, customer satisfaction 444, and KPIs 446.

Competitor 432 may include information related to the company, name, strategic importance, and industry of a competitor.

The KPIs 446 may include budget, importance, and strategic implication.

The sales cycle information 448 may include cycle type and typical closing period.

The involved product 450 may include a product identification and the importance of the product.

The risk 436 may include information related to risk based on importance factor and urgency factor.

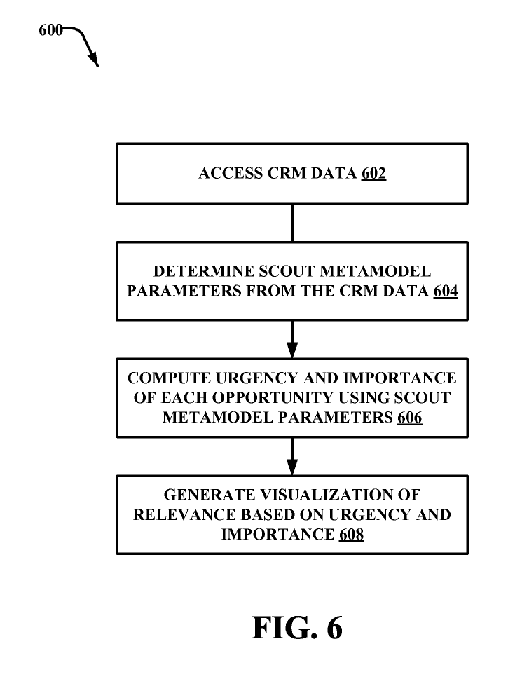

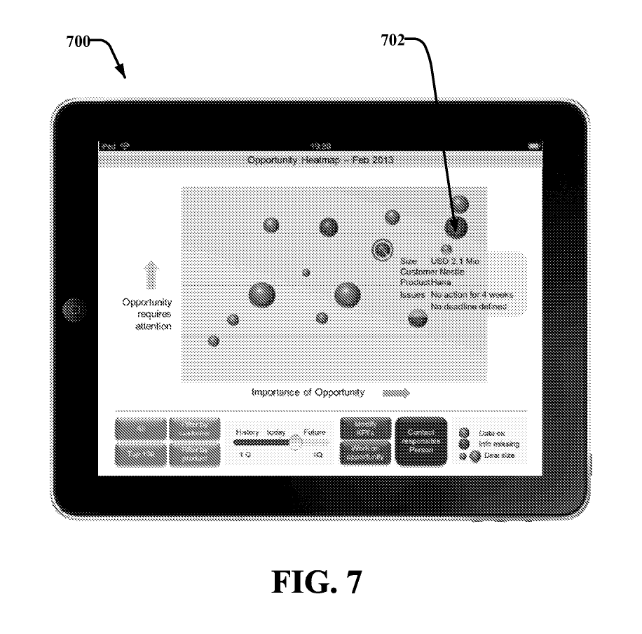

FIG. 6 is a flowchart of a method, in accordance with an example embodiment, for generating a visualization of relevance based on urgency and importance. At operation 602, the relevance reporter 114 accesses CRM data from CRM system 112 (for example, from the in-memory database 124). In one embodiment, the relevance reporter 114 accesses parameters relevant to the computation of an importance score and an urgency score of an opportunity as previously described.

At operation 604, the relevance reporter 114 determines metamodel parameters from the CRM data.

At operation 606, the relevance analyzer 116 calculates an urgency and importance of each object using the scout metalmodel parameters and ranks the object based on their corresponding relevance score. In one embodiment, the relevance analyzer 116 calculates an importance score and an urgency score for a plurality of objects of the CRM database. The importance score is computed based on a first plurality of parameters indicative of an importance of a sales opportunity. The urgency score is computed based on a second plurality of parameters indicative of an urgency of a sales opportunity.

At operation 608, the relevance analyzer 116 generates a visualization of objects have a corresponding relevance score exceeding a threshold score. Examples of visualization are illustrated in FIGS. 7-9.

FIG. 7 is a diagram illustrating an example of a user interface that includes a visualization of an opportunity heatmap 700. The drawing shows the status of the opportunities using the matrix 200 of FIG. 2. The x-axis represents the importance of the opportunity and y-axis represents the urgency to act on the opportunity. The size of the bubbles 702 represents the deal size, and the color is an indicator for the quality and completeness of the opportunity data in CRM. The heatmap 700 may show the opportunities of a single sales representative or a team and/or regarding a product group, a customer, or an industry.

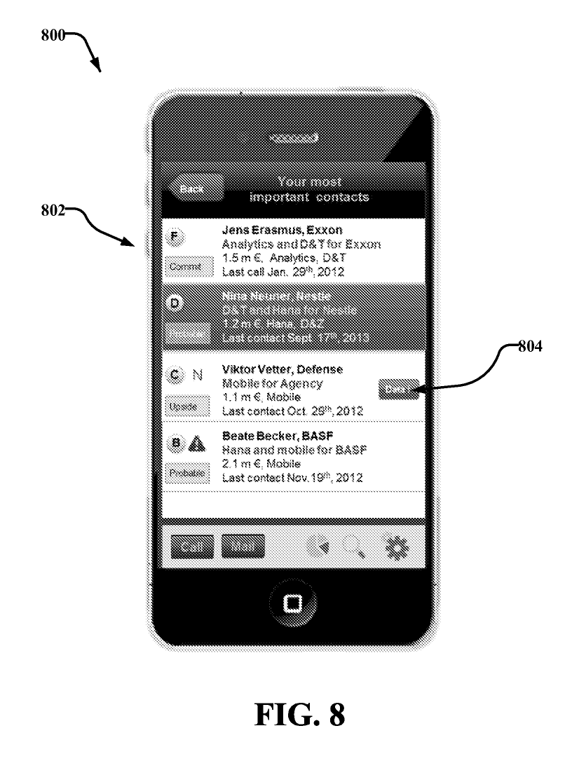

FIG. 8 is a diagram illustrating an example of a visualization of a list 800 of contacts 802 ranked by relevance of opportunities. The figure shows a mobile phone-based list of contacts with opportunity related data ranked by the relevance of the current opportunities. The list helps the user, for example, to decide about whom to call in case of unexpected spare time. In addition to the ranked list of contacts, opportunity related data 804 is shown.

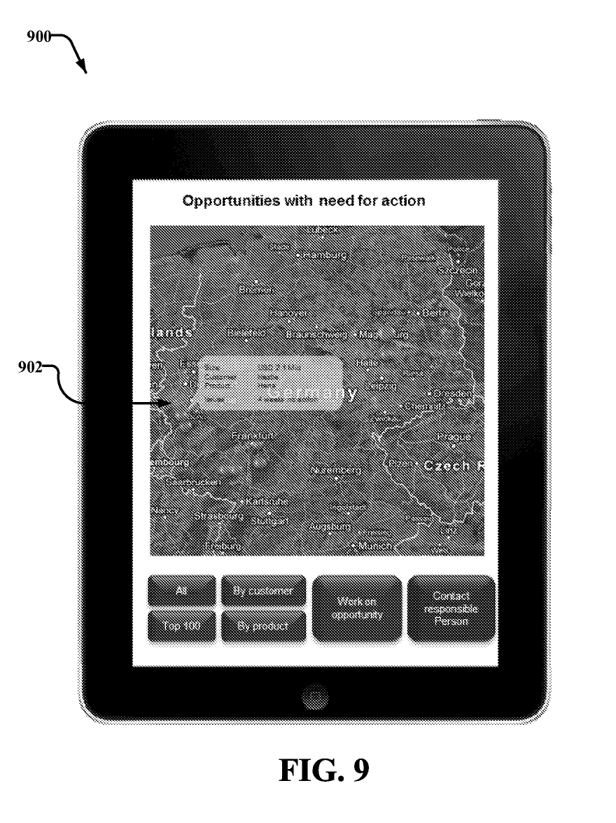

FIG. 9 is a diagram illustrating an example of a visualization of a map 900 showing the most relevant contacts 902 to visit. The map 900 shows the locations of main contacts of important opportunities or those in need of action. The map 900 presents an example of a sales trip itinerary and the identification of contacts to visit in case of spare time.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

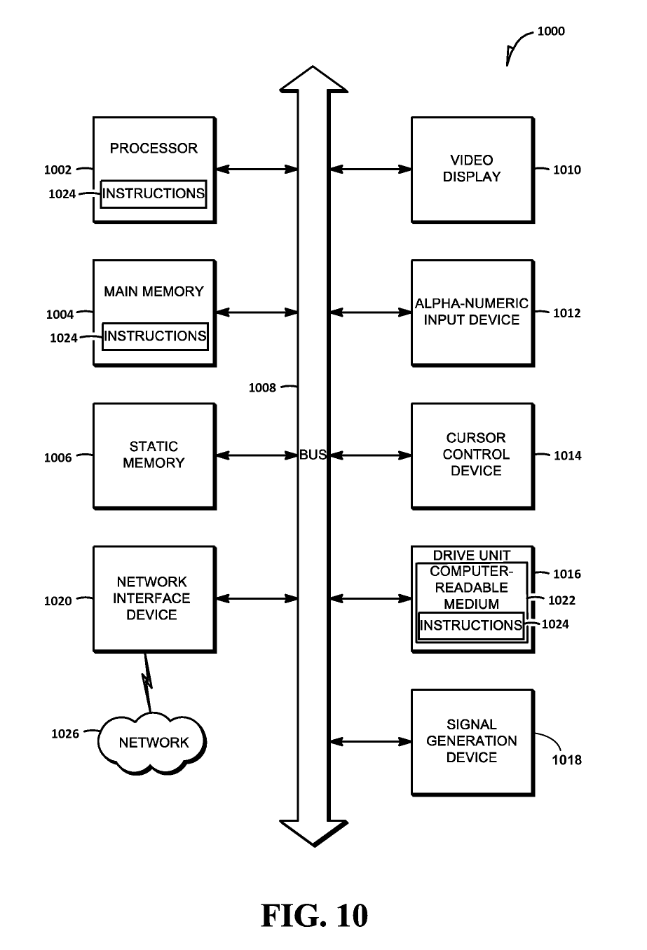

With reference to FIG. 10, an example embodiment extends to a machine in the example form of a computer system 1000 within which instructions 1024 for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 may include a processor 1002 (e.g., a central processing unit (CPU), a graphics processing unit (GPU), or both), a main memory 1004 and a static memory 1006, which communicate with each other via a bus 1008. The computer system 1000 may further include a video display unit 1010 (e.g., a liquid crystal display (LCD) or a cathode ray tube (CRT)). In example embodiments, the computer system 1000 also includes one or more of an alphanumeric input device 1012 (e.g., a keyboard), a user interface (UI) navigation device or cursor control device 1014 (e.g., a mouse), a disk drive unit 1016, a signal generation device 1018 (e.g., a speaker), and a network interface device 1020.

The disk drive unit 1016 includes a computer-readable storage medium 1022 on which is stored one or more sets of instructions 1024 and data structures (e.g., software instructions) embodying or used by any one or more of the methodologies or functions described herein. The instructions 1024 may also reside, completely or at least partially, within the main memory 1004 or within the processor 1002 during execution thereof by the computer system 1000, with the main memory 1004 and the processor 1002 also constituting machine-readable media.

While the computer-readable storage medium 1022 is shown in an exemplary embodiment to be a single medium, the term “computer-readable storage medium” may include a single storage medium or multiple media (e.g., a centralized or distributed database, or associated caches and servers) that store the one or more instructions 1024. The term “computer-readable storage medium” shall also be taken to include any tangible medium that is capable of storing, encoding, or carrying instructions for execution by the machine and that causes the machine to perform any one or more of the methodologies of embodiments of the present description, or that is capable of storing, encoding, or carrying data structures used by or associated with such instructions. The term “computer-readable storage medium” shall accordingly be taken to include, but not be limited to, solid-state memories, optical and magnetic media, and non-transitory machine-readable storage media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 and utilizing any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

It should be noted that various modifications and changes may be made to these example embodiments without departing from the broader spirit and scope of the present disclosure.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of the example embodiments as represented by the appended claims. The specification and drawings are, accordingly, to be regarded in an illustrative rather than a restrictive sense.

What is claimed is:

1. A computer-implemented method comprising:
accessing a plurality of objects from a customer relationship management (CRM) database;
computing an importance score and an urgency score for the plurality of objects of the CRM database, the importance score computed based on a first plurality of parameters indicative of an importance of a sales opportunity, the urgency score computed based on a second plurality of parameters indicative of an urgency of a sales opportunity;
computing a relevance score for the plurality of objects using the importance score and the urgency score;
ranking the plurality of objects based on the corresponding relevance score; and
generating in a display, a visualization of one or more objects from the plurality of objects having corresponding relevance scores exceeding a relevance score threshold.

2. The computer-implemented method of claim 1, further comprising:
accessing a first set of data from the CRM database and a second set of data from at least one system external to the CRM database;
augmenting the first set of data with the second set of data having a same structure as the first set of data; and
forming an opportunity metamodel using the augmented first set of data.

3. The computer-implemented method of claim 2, further comprising:
customizing the augmented first set of data in response to a user input; and
forming the opportunity metamodel using the customized and augmented first set of data.

4. The computer-implemented method of claim 2, further comprising:
computing the importance score by applying the opportunity metamodel to the first plurality of parameters; and
computing the urgency score by applying the opportunity metamodel to the second plurality of parameters.

5. The computer-implemented method of claim 1, wherein the first plurality of parameters comprises an effort spent parameter, a revenue parameter, a phase parameter, an opportunity type parameter, a forecast parameter, a source parameter, a product parameter, a partner parameter, an industry parameter, a risk parameter, a customer satisfaction parameter, a topdeal parameter, an achievement parameter, and an incentive parameter,
wherein the importance score is based on a sum of the first plurality of parameters.

6. The computer-implemented method of claim 1, wherein the second plurality of parameters comprises an opportunity dependent target frequency parameter, an immediate action parameter, a follow up activity parameter, a data of last activity parameter, and a present date parameter; and
wherein the opportunity dependent target frequency parameter is based on a customizable standard target frequency for customer contacts parameter and an increasing target contact frequency parameter.

7. The computer-implemented method of claim 1, further comprising:
generating a list of sales leads ranked by relevance based on the relevance score.

8. The computer-implemented method of claim 1, further comprising:
generating a list of contacts to be contacted based on the relevance score.

9. The computer-implemented method of claim 1, further comprising:
adjusting reminders and time management activities based on the relevance score.

10. The computer-implemented method of claim 1, further comprising:
generating an itinerary map for a sales related trip based on the relevance score.

11. A system comprising:
a storage device comprising a customer relationship management (CRM) database;
a relevance scout application implemented using a processor, the relevance scout application comprising:
a relevance reporter configured to access a plurality of objects from the CRM database, to compute an importance score and an urgency score for the plurality of objects, the importance score computed based on a first plurality of parameters indicative of an importance of a sales opportunity, the urgency score computed based on a second plurality of parameters indicative of an urgency of a sales opportunity; and
a relevance analyzer configured to compute a relevance score for the plurality of objects using the importance score and the urgency score, rank the plurality of objects based on the corresponding relevance score, and generate a visualization of one or more objects from the plurality of objects having corresponding relevance scores exceeding a relevance score threshold.

12. The system of claim 11, wherein the relevance reporter is configured to:
access a first set of data from the CRM database and a second set of data from at least one system external to the CRM database;
augment the first set of data with the second set of data having a same structure as the first set of data; and
form an opportunity metamodel using the augmented first set of data.

13. The system of claim 12, wherein the relevance analyzer is configured to:
customize the augmented first set of data in response to a user input; and
form the opportunity metamodel using the customized and augmented first set of data.

14. The system of claim 12, wherein the relevance analyzer is configured to:
compute the importance score by applying the opportunity metamodel to the first plurality of parameters; and
compute the urgency score by applying the opportunity metamodel to the second plurality of parameters.

15. The system of claim 11, wherein the first plurality of parameters comprises an effort spent parameter, a revenue parameter, a phase parameter, an opportunity type parameter, a forecast parameter, a source parameter, a product parameter, a partner parameter, an industry parameter, a risk parameter, a customer satisfaction parameter, a topdeal parameter, an achievement parameter, and an incentive parameter; and
wherein the importance score is based on a sum of the first plurality of parameters.

16. The system of claim 11, wherein the second plurality of parameters comprises an opportunity dependent target frequency parameter, an immediate action parameter, a follow up activity parameter, a data of last activity parameter, a present date parameter; and
wherein the opportunity dependent target frequency parameter is based on a customizable standard target frequency for customer contacts parameter and an increasing target contact frequency parameter.

17. The system of claim 11, wherein the relevance analyzer is configured to:
generate a list of leads ranked by relevance based on the relevance score.

18. The system of claim 11, wherein the relevance analyzer is configured to:
generate a list of contacts to be contacted based on the relevance score.

19. The system of claim 11, wherein the relevance analyzer is configured to:
generate an itinerary plan for a sales related trip based on the relevance score.

20. A non-transitory machine-readable storage medium storing instructions which, when executed by at least one processor, performs operations comprising:
accessing a plurality of objects from a customer relationship management (CRM) database;
computing an importance score and an urgency score for the plurality of objects of the CRM database, the importance score computed based on a first plurality of parameters indicative of an importance of a sales opportunity, the urgency score computed based on a second plurality of parameters indicative of an urgency of a sales opportunity;
computing a relevance score for the plurality of objects using the importance score and the urgency score;
ranking the plurality of objects based on the corresponding relevance score; and
generating a visualization of one or more objects from the plurality of objects having corresponding relevance scores exceeding a relevance score threshold.
